(19) United States
(12) Patent Application Publication
(10) Pub. No.: US 2025/0218338 A1
(43) Pub. Date: Jul. 3, 2025

(54) Method of controlling display panel and related display driver circuit

(71) Applicant: NOVATEK Microelectronics Corp., Hsin-Chu (TW)

(72) Inventor: Huan-Teng Cheng, Hsinchu City (TW)

(73) Assignee: NOVATEK Microelectronics Corp., Hsin-Chu (TW)

(21) Appl. No.: 18/827,863

(22) Filed: Sep. 9, 2024

Related U.S. Application Data
(60) Provisional application No. 63/615,278, filed on Dec. 28, 2023.

(51) Int. Cl. G09G 3/20

(52) U.S. Cl. CPC G09G 3/2096; G09G 2330/021; G09G 2340/0435; G09G 2360/18; G09G 2370/00

(57) ABSTRACT

A method of controlling a display panel for a display driver circuit having a frame buffer includes steps of: receiving a first frame of display data and sending the first frame of display data to the display panel by bypassing the frame buffer; starting counting time in a time period for receiving the first frame of display data, to determine whether a timeout occurs; receiving a second frame of display data after the timeout occurs; and writing the second frame of display data into the frame buffer.

### CROSS REFERENCE TO RELATED APPLICATIONS

This application claims the benefit of U.S. Provisional Application No. 63/615, 278, filed on Dec. 28, 2023. The content of the application is incorporated herein by reference.

### BACKGROUND OF THE INVENTION

### 1. Field Of The Invention

The present invention relates to a method of controlling a display panel, and more particularly, to a method of controlling a display panel in a hybrid mode.

### 2. Description Of The Prior Art

In a display system, the application processor (AP) transmits display data to the display driver circuit through a mobile industry processor interface (MIPI). There are two commonly used transmission modes on the MIPI: the command mode and the video mode. In order to gain the benefits of both the command mode and the video mode, the industry has proposed a hybrid mode for the MIPI specification, which is equivalent to a mixture of the command mode and the video mode.

In the prior art, the display driver circuit supporting the hybrid mode is requested to perform mode switching according to the usage scenario of the display system, which may be determined by the AP. In detail, the AP should first determine the usage scenario and then send a command to inform the display driver circuit to change its operation mode. The AP may not determine the most appropriate image sending method in every usage scenario; hence, the power saving effect achieved by the hybrid mode is limited.

### SUMMARY OF THE INVENTION

It is therefore an objective of the present invention to provide a method of controlling a display panel and a related display driver circuit supporting the hybrid mode, in order to solve the abovementioned problems.

An embodiment of the present invention discloses a method of controlling a display panel for a display driver circuit, wherein the display driver circuit has a frame buffer. The method comprises steps of: receiving a first frame of display data and sending the first frame of display data to the display panel by bypassing the frame buffer; starting counting time in a time period for receiving the first frame of display data, to determine whether a timeout occurs; receiving a second frame of display data after the timeout occurs; and writing the second frame of display data into the frame buffer.

Another embodiment of the present invention discloses a display driver circuit for controlling a display panel, wherein the display driver circuit has a frame buffer. The display driver circuit receives a first frame of display data and sends the first frame of display data to the display panel by bypassing the frame buffer; starts counting time in a time period for receiving the first frame of display data, to determine whether a timeout occurs; receives a second frame of display data after the timeout occurs; and writes the second frame of display data into the frame buffer.

Another embodiment of the present invention discloses a method of controlling a display panel for a display driver circuit, wherein the display driver circuit has a frame buffer. The method comprises steps of: receiving a first frame of display data and writing the first frame of display data into the frame buffer; receiving a second frame of display data which is not in response to a control signal of the display driver circuit after receiving the first frame of display data; outputting the second frame of display data to the display panel by bypassing the frame buffer.

Another embodiment of the present invention discloses a display driver circuit for controlling a display panel, wherein the display driver circuit has a frame buffer. The display driver circuit receives a first frame of display data and writes the first frame of display data into the frame buffer; receives a second frame of display data which is not in response to a control signal of the display driver circuit after receiving the first frame of display data; and outputs the second frame of display data to the display panel by bypassing the frame buffer.

Another embodiment of the present invention discloses a method of controlling a display panel for a display driver circuit, wherein the display driver circuit has a frame buffer. The method comprises steps of: receiving a plurality of display data; determining a frequency of the plurality of display data; and writing the plurality of display data into the frame buffer or outputting the plurality of display data to the display panel by bypassing the frame buffer according to the frequency.

Another embodiment of the present invention discloses a display driver circuit for controlling a display panel, wherein the display driver circuit has a frame buffer. The display driver circuit receives a plurality of display data; determines a frequency of the plurality of display data; and writes the plurality of display data into the frame buffer or outputs the plurality of display data to the display panel by bypassing the frame buffer according to the frequency.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display system according to an embodiment of the present invention.

FIG. 2 is a schematic diagram of a display system using a general hybrid mode to perform display data transmission.

FIG. 3 is a waveform diagram of signal transmission between the AP and the DDIC in a general hybrid mode.

FIG. 4 is a waveform diagram of signal transmission between the AP and the DDIC in another scenario of the general hybrid mode.

FIG. 5 is a schematic diagram of a display system using the hybrid mode to transmit display data according to an embodiment of the present invention.

FIG. 6 and FIG. 7 are waveform diagrams of signal transmission between the AP and the DDIC in the hybrid mode according to embodiments of the present invention.

FIG. 8 is a waveform diagram of signal transmission between the AP and the DDIC in the hybrid mode according to another embodiment of the present invention.

FIG. 9 is a flowchart of a control process of the DDIC according to an embodiment of the present invention.

FIG. 10 illustrates a detailed implementation of the DDIC deciding whether to be switched to the read/write mode based on timeout determination.

FIG. 11 is a waveform diagram of signal transmission of the DDIC switched from the read/write mode to the bypass mode according to an embodiment of the present invention.

FIG. 12 is a flowchart of a control process of the DDIC according to an embodiment of the present invention.

FIG. 13 illustrates another implementation of the DDIC switched from the read/write mode to the bypass mode.

FIG. 14 illustrates another implementation of the DDIC switched from the bypass mode to the read/write mode.

FIG. 15 illustrates another alternative embodiment where the DDIC is switched from the bypass mode to the command mode.

FIG. 16 is a flowchart of a control process according to an embodiment of the present invention.

### DETAILED DESCRIPTION

According to the specification of the mobile industry processor interface (MIPI), the display driver circuit supporting the command mode contains a frame buffer. When the display driver circuit is operated in the command mode, the display data from the MIPI may be written into the frame buffer and then read out from the frame buffer at appropriate time point(s) to refresh the panel. The video mode is applied to a display driver circuit that may not contain a frame buffer. When receiving display data through the MIPI, the display driver circuit may directly forward the display data to refresh the display panel. In the hybrid mode, the host processor may send images in a manner similar as in the video mode, but the display driver circuit may selectively write the received display data into the frame buffer or control the display data to bypass the frame buffer to be directly output to the display panel for refresh.

A low temperature polycrystalline oxide (LTPO) panel supports an extremely low frame rate such as 1 Hz. If the display panel is directly switched to the extremely low frame rate of 1 Hz from the display of a high frame rate of 120 Hz, it will easily cause visual effect problems such as screen flickering. Therefore, the MIPI Association has proposed an adaptive refresh panel (ARP) mechanism to enter the extremely low frame rate from the high frame rate display in panel refresh through the sequential frequency down-conversion method, so as to solve the above visual effect problems and also obtain power saving effects. Based on the ARP operations, the host processor will not actively send images when the images are not updated, and will send images when receiving a control signal sent by the display driver circuit. At this time, the display driver circuit may send the control signal to instruct the host processor to send images at specific time points during the ARP operations, to achieve the purpose of sequential frequency down-conversion.

In general, the host processor in the hybrid mode sends images in a similar manner as in the video mode, but the display driver circuit may selectively write the display data into the frame buffer or control the display data to bypass the frame buffer to be directly forwarded to the display panel. Therefore, as for the ARP operations, the display driver circuit only needs to receive the updated display data once from the host processor and store these display data in the frame buffer, and then reads out the display data by controlling the frame buffer using the internal clock, to perform panel refresh with sequentially down-converted frequencies. The display driver circuit does not need to trigger the host processor to send images multiple times, and this significantly reduces the power consumption of image sending on the MIPI and improves the display efficiency.

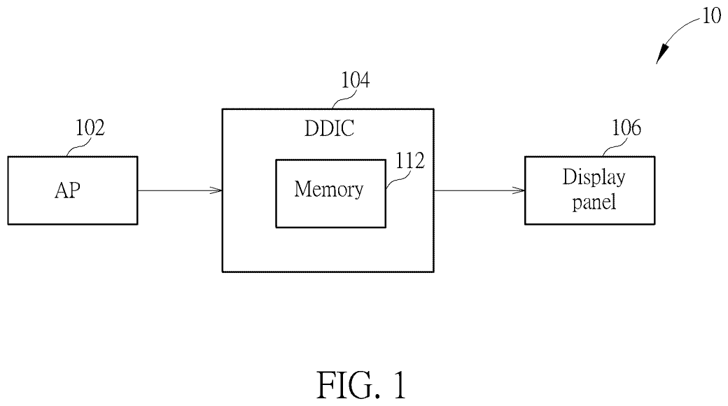

FIG. 1 is a schematic diagram of a display system 10 according to an embodiment of the present invention. The display system 10 includes a host processor 102, a display driver circuit 104 and a display panel 106. The host processor 102, which may be a core processor of the display system 10, may serve as a video source or video provider for providing display data to be displayed by the display panel 106. In an embodiment, the host processor 102 may be an application processor (AP) of a mobile phone or a central processing unit (CPU) of a computer. In the following descriptions, the host processor may be abbreviated as AP, but those skilled in the art would know that the AP described hereinafter may represent any type of processor or processing device capable of controlling the display operations and implemented in any manner.

The display driver circuit 104 may process the display data and convert the display data into data voltages to be output to the pixels on the display panel 106. In an embodiment, the display driver circuit 104 may be implemented in an integrated circuit (IC) to realize a display driver IC (DDIC). In the following descriptions, the display driver circuit will be abbreviated as DDIC, and those skilled in the art would know that the DDIC described hereinafter may represent a display driver circuit capable of driving a display panel and implemented in any manner.

Since the DDIC 104 supports the hybrid mode, the DDIC 104 may include a memory 112, in which a frame buffer is implemented. Examples of the memory 112 may include a random access memory (RAM), but not limited thereto.

The display panel 106 may be any type of display device, which may be, but not limited to, an organic light emitting diode (OLED) panel, liquid crystal display (LCD) panel, or any other panel performing display by receiving scan control.

In various embodiments of the present invention, the DDIC 104 supports the hybrid mode, where the display data received by the DDIC 104 may be selectively written into the frame buffer implemented in the memory 112, or forwarded to the display panel 106 to perform refresh by bypassing the frame buffer. The operations of writing the display data into the frame buffer mean that the received display data may be compressed in an appropriate manner and then the compressed display data are stored in the memory 112. The operations of forwarding the display data to the display panel 106 mean that a processing circuit of the DDIC 104 may process the display data and convert the display data into corresponding data voltages, and an output driver of the DDIC 104 may output the data voltages to the display panel 106. In such a situation, neither the display data nor the data voltages are stored in the memory 112.

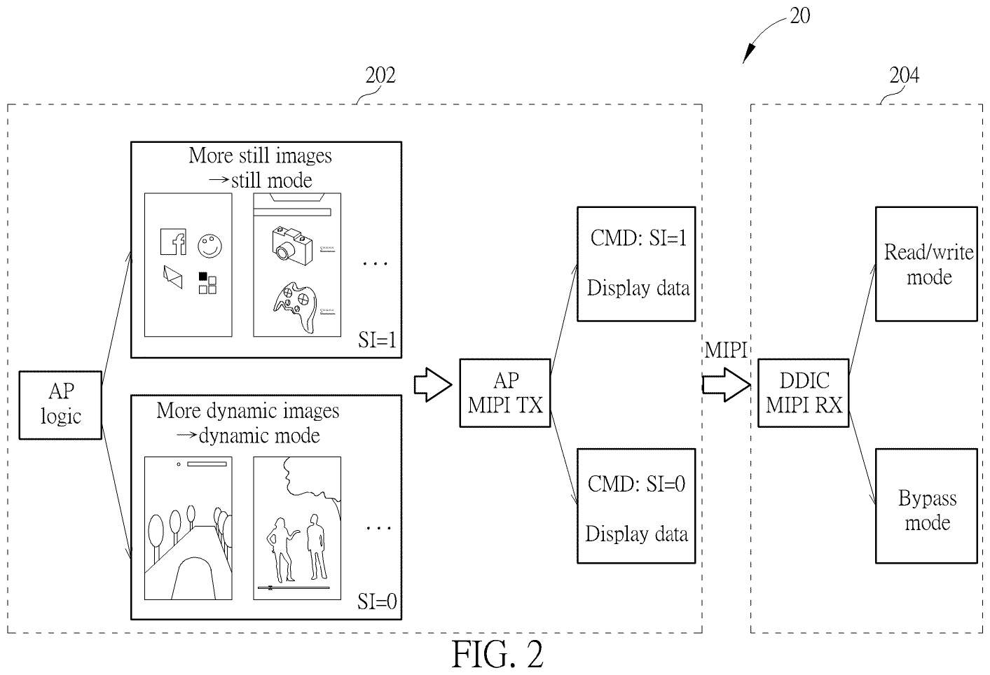

FIG. 2 is a schematic diagram of a display system 20 using a general hybrid mode to perform display data transmission. The display system 20 includes an AP 202, a DDIC 204, and a display panel (omitted in FIG. 2 for brevity). According to the application scenario, the AP 202 may determine that the images to be displayed have more still images or more dynamic images, e.g., through a logic unit of the AP 202. Therefore, the MIPI transmitter of the AP 202 may send a command CMD carrying a still indication SI to the DDIC 204 through the MIPI. In this example, it is assumed that the still indication SI equal to 1 represents the scenarios with more still images, such as a UI interface, webpage, etc.; and the still indication SI equal to 0 represents the scenarios with more dynamic images, such as a game, video, etc. Subsequently, when the AP 202 transmits display data to the DDIC 204, it may send the corresponding still indication SI, so that the DDIC 204 may appropriately process the received display data according to the still indication SI.

In detail, the DDIC 204 may decide to be operated in the read/write mode or bypass mode according to the still indication SI. In the read/write mode, the DDIC 204 may write the received display data into the frame buffer (which may be implemented in a built-in memory such as the memory 112 shown in FIG. 1); hence, the display data may be read out from the frame buffer to perform refresh when the images on the display panel need to be updated subsequently. In the bypass mode, the DDIC 204 may control the received display data to bypass the frame buffer to be directly sent to the display panel to perform refresh.

As can be seen from above, the AP 202 may determine the value of the still indication SI by using the logic unit in its upper layer, where the upper layer may determine the operation mode before the graphics layer performs image processing and generates the output display data. For example, the algorithm of the AP 202 may determine an application (app) that the mobile phone needs to enter belongs to which type, determine the image content attributes that the app may display, and then instruct the AP 202 which mode to enter (e.g., the still mode or dynamic mode). The AP 202 may also correspondingly send the still indication SI to the DDIC 204, to instruct the DDIC 204 to enter the read/write mode or bypass mode. When this app is operating, the AP 202 and the DDIC 204 are configured to always operate in the predetermined mode and cannot be switched dynamically.

However, an app does not necessarily have all dynamic images or all still images, but only one of the operation modes may be selected for this app, resulting in limited benefits of the hybrid mode. In addition, the manufacturer of the mobile phone may not be able to correctly understand the attributes of each app and select the accurate operation mode. For example, the AP 202 may be predefined to operate in the still mode when it is not able to determine the app's attribute. However, if this app has more dynamic images but the DDIC 204 is instructed to be operated in the read/write mode, the DDIC 204 will perform a large number of read and write operations, resulting in considerable power consumption.

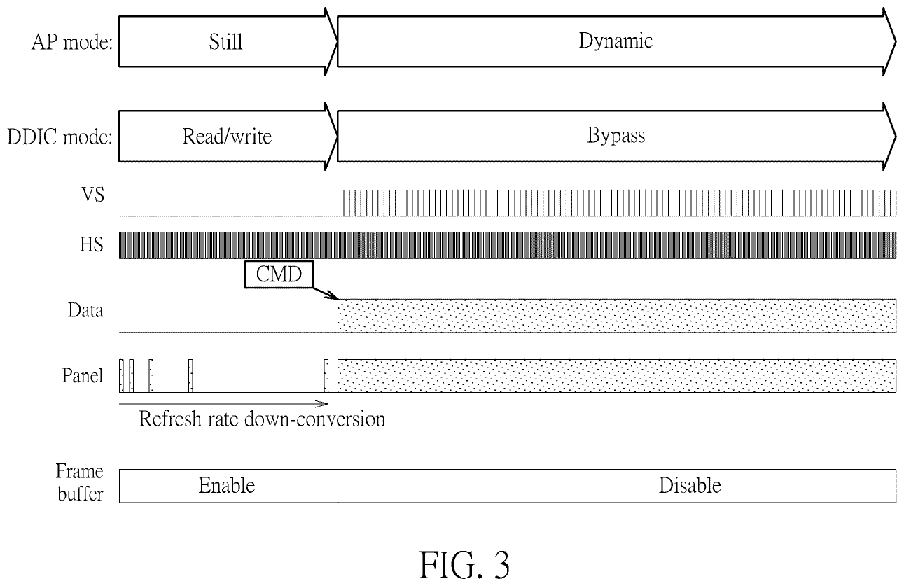

FIG. 3 is a waveform diagram of signal transmission between the AP 202 and the DDIC 204 in a general hybrid mode, where a vertical synchronization signal VS, a horizontal synchronization signal HS, and display data forwarded through the MIPI are illustrated. In addition, the operation modes of the AP 202 and the DDIC 204 and the operations of the display panel and the frame buffer are shown to facilitate the illustrations.

First, the AP 202 is in the still mode and may be displaying a still image such as a background image. Correspondingly, the DDIC 204 is operated in the read/write mode, and its frame buffer is enabled to store the previously received display data. At this time, the AP 202 does not need to send display data with the vertical synchronization signal VS to the DDIC 204, and the DDIC 204 may read the frame buffer through an internal clock, to output the display data to the display panel to perform refresh. Note that the horizontal synchronization signal HS may be a signal utilized by the DDIC 204 to synchronize various display operations, and this signal may be received from the AP 202 through the MIPI or a general purpose output (GPO) interface, or may be generated internally in the DDIC 204.

In an embodiment, in the read/write mode, the DDIC 204 may gradually decrease the refresh rate through the sequential frequency down-conversion method, e.g., gradually adjusting from 120 Hz to 1 Hz, in order to meet the requirements of visual effects under the ARP operations. Therefore, the display data for refresh may be read out from the frame buffer with sequentially down-converted frequencies.

After the user opens an app to trigger the AP 202 to enter the dynamic mode, the AP 202 may start to continuously send the vertical synchronization signal VS and display data to the DDIC 204. At the same time, the AP 202 may send a command CMD containing the still indication SI to the DDIC 204, to instruct the DDIC 204 to enter the bypass mode. The command CMD may be sent through the vertical front porch (VFP) in the display data channel of MIPI, but not limited thereto. In the bypass mode, the DDIC 204 may control the received display data to bypass the frame buffer to be directly sent to the display panel. The DDIC 204 may continuously receive display data from the AP 202 to refresh the panel, and the read/write functions of the frame buffer are disabled.

In the example of FIG. 3, the operation mode of the DDIC 204 is exactly controlled by the AP 202 through the command CMD; that is, after entering the bypass mode due to the command CMD received from the AP 202, the DDIC 204 may not leave the bypass mode until receiving another command. In such a situation, the DDIC 204 has to continuously refresh the display panel through the latest received display data. The display data may not be stored into the frame buffer, and the MIPI needs to continuously forward the display data from the AP 202 to the DDIC 204, so that the power consumption of the MIPI is unavoidable.

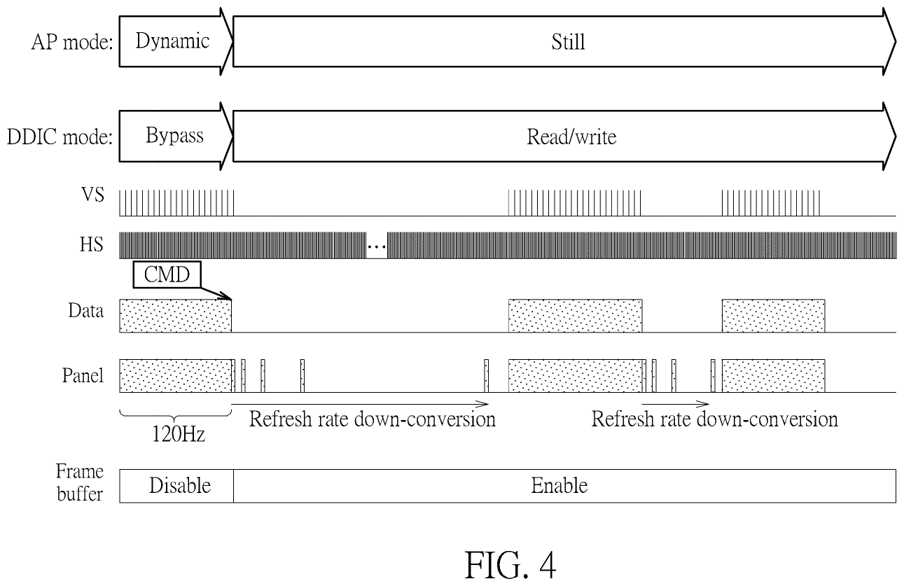

FIG. 4 is a waveform diagram of signal transmission between the AP 202 and the DDIC 204 in another scenario of the general hybrid mode, where the AP 202 is switched from the dynamic mode to the still mode and sends a command CMD containing the still indication SI to the DDIC 204 to instruct the DDIC 204 to enter the read/write mode from the bypass mode.

In the dynamic mode, the AP 202 may continuously transmit high-speed display data such as in the frame rate of 120 Hz, and the DDIC 204 in the bypass mode may forward the display data to the display panel for refresh by bypassing the frame buffer. When receiving a command CMD having the still indication SI that indicates the start of a still image, the DDIC 204 enters the read/write mode. In the read/write mode, the frame buffer of the DDIC 204 keeps enabled. As long as the AP 202 transmits any display data through the MIPI, the DDIC 204 will write the display data into the frame buffer. Since the DDIC 204 performs mode switching only based on the still indication SI from the AP 202, if no relevant command is received and the AP 202 continuously sends images, a large amount of power consumption in the read/write operations of the frame buffer will be generated.

In general, in order to save the storage space, the display data needs to be compressed before being written into the frame buffer, and the operations of reading the display data from the frame buffer requires corresponding decompression. The operations of compression and decompression require a large amount of calculation and thus generate considerable power consumption. For example, as shown in FIG. 4, there are several time periods in which the AP 202 outputs high-speed display data but the DDIC 204 is in the read/write mode and performs the read/write operations. In contrast, if the display data from MIPI may bypass the frame buffer to be directly sent to the display panel for refresh, a large amount of power consumption in the read/write operations may be saved, especially when the AP 202 continuously sends images.

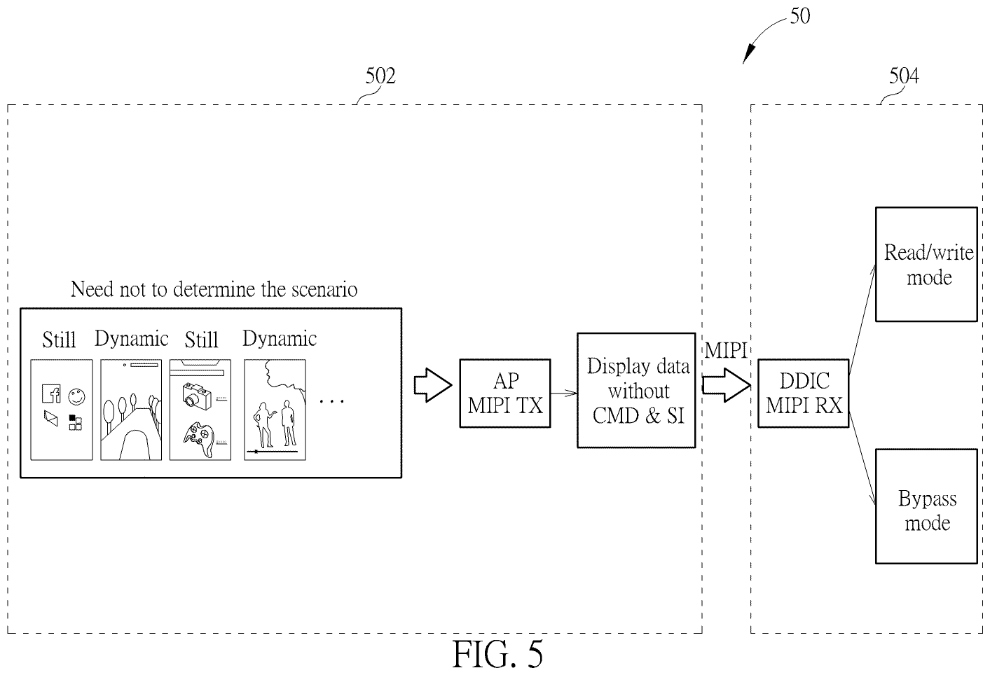

FIG. 5 is a schematic diagram of a display system 50 using the hybrid mode to transmit display data according to an embodiment of the present invention. The display system 50 includes an AP 502, a DDIC 504, and a display panel (omitted in FIG. 5 for brevity). Different from the operations in FIG. 2, in this embodiment, the AP 502 does not need to determine the usage scenario or change the operation mode, and also not need to send a still indication SI and the related command CMD to the DDIC 504. The DDIC 504 may perform determination according to the frame rate of the display data received from the AP 502, and automatically switch the operation mode. Regardless of the usage scenario or situation, the DDIC 504 may determine the frequency of the AP 502 sending images based on the display data received through the MIPI, and determine whether it should be switched to the read/write mode or bypass mode accordingly.

For example, when receiving the display data with a higher frequency, the DDIC 504 may determine that the AP 502 sends images with a higher frame rate, which means that the image sending frequency may be higher than a first threshold. At this time, the DDIC 504 may enter the bypass mode to directly output the display data to the display panel by bypassing the frame buffer, thereby reducing the number of reads and writes in the frame buffer. The reduced read/write operations will further reduce the power consumption required for the memory. When receiving the display data with a lower frequency, the DDIC 504 may determine that the AP 502 sends images with a lower frame rate, which means that the image sending frequency may be lower than a second threshold (which may be identical to or different from the first threshold). At this time, the DDIC 504 may enter the read/write mode and write the received display data into the frame buffer, and then read out the display data from the frame buffer at appropriate time point(s) to refresh the panel, e.g., through the control of the internal clock. This will reduce the power consumption of image sending through the MIPI.

In an embodiment, the DDIC 504 may use a timer or a timeout counter to determine the image sending frequency of the AP 502. As long as the image sending frequency falls to a certain threshold, a timeout will be triggered, and the DDIC 504 may enter the read/write mode accordingly.

As for the AP 502, it only needs to send images with a variable frame rate based on the display image content; that is, the AP 502 may continuously update the display data with a higher frame rate for dynamic images (e.g., when playing videos), while transmitting no display data or few display data for still images. The logic unit in the upper layer of the AP 502 does not need to determine whether the transmitted images are dynamic images or still images, and the AP 502 does not need to determine which scenario the app to be opened by the user belongs to. Therefore, regardless of the usage scenario, the AP 502 only needs to send images based on the predetermined timing, so there is no dynamic mode or still mode. In addition, the AP 502 does not need to send a command CMD or a still indication SI to notify the DDIC 504 to change the operation mode. The DDIC 504 may be switched between the read/write mode and the bypass mode by itself without being instructed by any command or indication received from the AP 502.

The AP and the DDIC described in the following embodiments may be the AP 502 and the DDIC 504 in the display system 50 shown in FIG. 5, and/or the host processor 102 and the display driver circuit 104 in the display system 10 shown in FIG. 1, but not limited thereto.

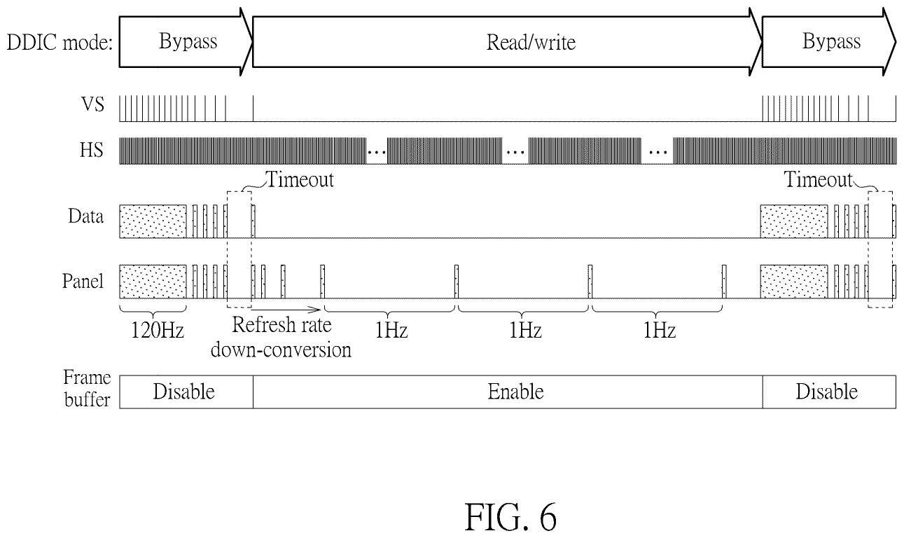

FIG. 6 is a waveform diagram of signal transmission between the AP and the DDIC in the hybrid mode according to an embodiment of the present invention, where the waveforms of a vertical synchronization signal VS, a horizontal synchronization signal HS and display data, the operation mode of the DDIC, and the operations of panel refresh and the frame buffer are shown.

First, assuming that the display system is playing a movie with a high refresh rate, the AP continuously outputs display data in a high frequency through the MIPI at this time. Since the DDIC receives continuous full-speed display data along with the vertical synchronization signal VS sent by the AP, it may operate in the bypass mode, where the frame buffer is disabled and bypassed, and the DDIC continuously refreshes the display panel based on a series of display data received from the AP. More specifically, the read and write functions of the frame buffer included in the DDIC are disabled. In such a situation, the DDIC may control the display data to bypass the frame buffer and directly forward the display data to the display panel for refresh.

After the movie is completely played, the AP will no longer actively update images and stop transmitting display data. The AP may gradually decrease the image sending frequency, e.g., through the sequential frequency down-conversion method. When the image sending frequency falls below a certain level, the DDIC may leave the bypass mode to enter the read/write mode, and the subsequently received display data will be written into the frame buffer.

The DDIC may perform the mode switch through time counting. In an embodiment, the DDIC may start counting time in each time period for receiving a frame of display data. For example, the DDIC may start counting time every time it receives a vertical synchronization signal VS from the AP, where the vertical synchronization signal VS indicates the start of a time period for transmitting a frame of display data. The DDIC may also set a timeout length, so as to determine whether a timeout occurs based on the timing result. When determining that the timeout occurs, which means that no vertical synchronization signal VS is received for a predetermined period of time exceeding the timeout length, the DDIC may leave the bypass mode to enter the read/write mode. The timeout means that the AP does not actively update images for more than a period of time, which means that the frequency of the AP sending images falls below a certain level. For example, the DDIC may set the timeout length to an appropriate value so that it is expected to enter the read/write mode when the frequency of the output vertical synchronization signal VS falls below 20 Hz, which means that the image sending frequency of the AP falls below 20 Hz.

Through the above timeout mechanism, the DDIC does not need to receive any command from the AP to indicate whether to enter the read/write mode. The DDIC may leave the bypass mode and enter the read/write mode only based on the frame rate or frequency of the received display data.

The above time counting scheme used for determining the occurrence of timeout may be implemented in any manner. In an embodiment, a timeout counter may be applied to calculate the number of horizontal synchronization signals HS continuously received after the DDIC receives the vertical synchronization signal VS, so as to determine whether the timeout occurs. Therefore, when the number of accumulated horizontal synchronization signals HS exceeds a specific value, the DDIC may determine that a timeout occurs and thereby enter the read/write mode.

After entering the read/write mode, the DDIC may refresh the display panel by reading out the display data from the frame buffer. As shown in FIG. 6, the DDIC may refresh the display panel with sequentially down-converted refresh rates, e.g., from 120 Hz to 1 Hz. Therefore, the display data may be read out from the frame buffer with the sequentially down-converted refresh rates if the AP does not update the images, and the power consumption generated from data transmission through the MIPI may be saved.

Subsequently, when the AP needs to update the display images while the DDIC is in the read/write mode, the AP will start to continuously transmit the updated display data. When receiving the updated display data continuously transmitted by the AP, the DDIC may automatically return to the bypass mode. Similarly, the DDIC performs determination entirely based on the way the AP sends images, and thus does not need to receive an additional command CMD or still indication SI from the AP to indicate whether to enter the bypass mode.

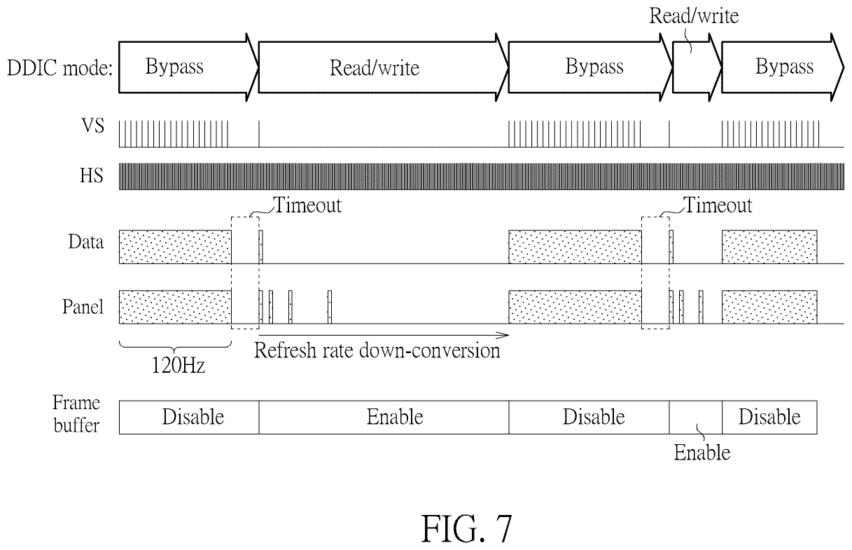

FIG. 7 illustrates an image sending situation similar to FIG. 4, but the mode switching method of the present invention is applied. In FIG. 4, no matter how the AP sends images, the operation mode of the DDIC is switched only by recognizing the command CMD with the still indication from the AP. In contrast, in FIG. 7, when the AP continuously changes the image sending frequency, the DDIC may be adjusted to the read/write mode or the bypass mode accordingly, to process the display data in the most efficient way to achieve the optimal power saving.

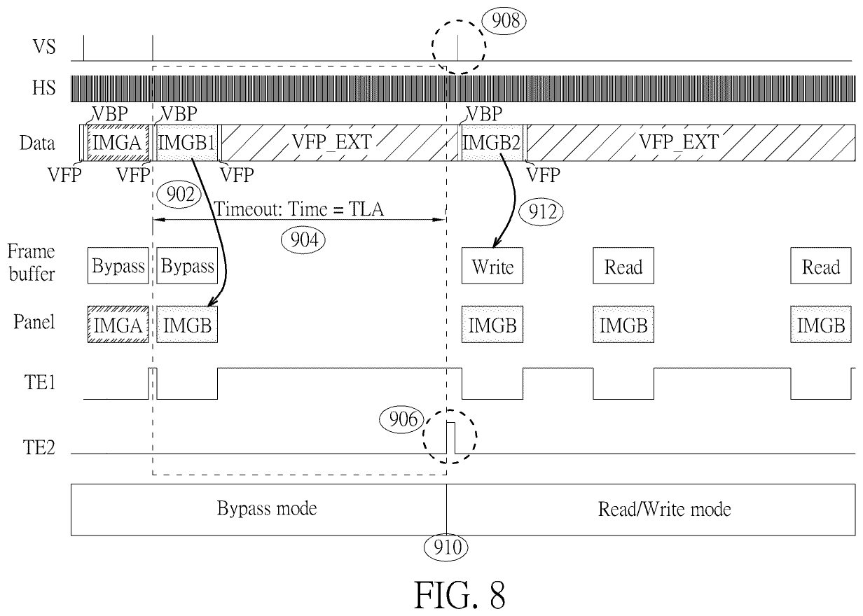

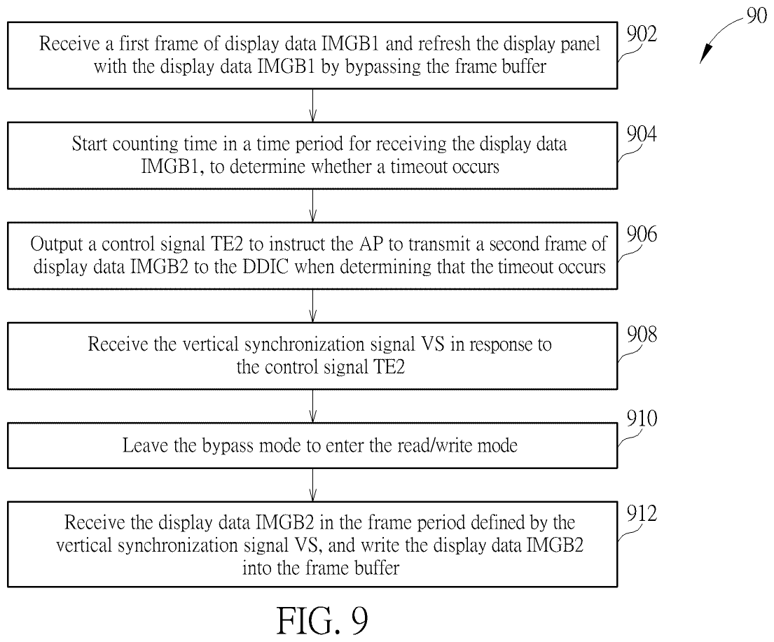

FIG. 8 is a waveform diagram of signal transmission between the AP and the DDIC in the hybrid mode according to an embodiment of the present invention, where the detailed operations of mode switching of the DDIC are illustrated. FIG. 9 is a flowchart of a control process 90 of the DDIC, which corresponds to the waveforms shown in FIG. 8. As shown in FIG. 9, the control process 90 includes the following steps:

Step 902: Receive a first frame of display data IMGB1 and refresh the display panel with the display data IMGB1 by bypassing the frame buffer.

Step 904: Start counting time in a time period for receiving the display data IMGB1, to determine whether a timeout occurs.

Step 906: Output a control signal TE2 to instruct the AP to transmit a second frame of display data IMGB2 to the DDIC when determining that the timeout occurs.

Step 908: Receive the vertical synchronization signal VS in response to the control signal TE2.

Step 910: Leave the bypass mode to enter the read/write mode.

Step 912: Receive the display data IMGB2 in the frame period defined by the vertical synchronization signal VS, and write the display data IMGB2 into the frame buffer.

Referring to the waveforms of FIG. 8 along with the control process 90 of FIG. 9, the DDIC may be in the bypass mode first, and may forward the display data (e.g., IMGA, IMGB1 . . . ) from the AP to the display panel to perform refresh, where the frame buffer is bypassed. Simultaneously, the DDIC may count time in each frame period and monitor the timeout. When the DDIC does not receive the vertical synchronization signal VS (and the display data) from the AP for more than a period of time, it may determine that the image sending frequency of the AP falls below a certain threshold and thus a timeout occurs. As mentioned above, the timeout length may be set to an appropriate value. In this embodiment, the timeout length may be equal to TLA, which is a threshold for the scenario of triggering the DDIC to be switched from the bypass mode to the read/write mode. The occurrence of timeout may be determined if the counted time reaches the timeout length TLA but no updated images are received. At this time, the DDIC may enter the read/write mode from the bypass mode, and send the control signal TE2 to the AP.

In response to the control signal TE2, the AP may send a vertical synchronization signal VS with the display data (e.g., IMGB2) to the DDIC. Since the DDIC enters the read/write mode, it will write the display data IMGB2 into the frame buffer. In general, the display data IMGB2 output based on the trigger of the control signal TE2 are not actively updated images, and thus the image content of the display data IMGB2 may be identical to the image content of the display data IMGB1 (e.g., both are IMGB, as shown in FIG. 8).

Note that the AP supports a variable frame rate, where the frequency that the AP transmits a series of frames of display data is variable. The variable frame rate may be realized in any manner. For example, the AP may reduce the image sending frequency by extending the VFP interval, and different VFP lengths may correspond to different frame rates. As shown in FIG. 8, the extended VFP interval is denoted by VFP EXT.

According to the MIPI specification, the DDIC and the AP are requested to communicate with each other through a control signal TE1. The DDIC may send the control signal TE1 to the AP, to indicate whether the AP is allowed to write images at this time. In this embodiment, the control signal TE1 may be realized by using a control pin connected between the AP and the DDIC. The control pin in the high level indicates a state that image writing is allowable, and in the low level indicates a state that image writing is not allowable. For example, when reading out (decompressing) display data from the frame buffer for refreshing the display panel, the DDIC will pull the control signal TEL low to inform the AP that it cannot write images at this time. In addition, when the DDIC receives the vertical synchronization signal VS and starts to receive and process display data from the AP, it will also pull the control signal TEL low until the display data is completely received. Therefore, as for the switching in the hybrid mode, the DDIC may use an additional control signal TE2 to communicate with the AP, to instruct the AP to send images at an appropriate time point. In an embodiment, the control signal TE2 may be a control pin connected between the AP and the DDIC, such as a GPO pin. In an embodiment, the control pin may be in the low level in usual, and the DDIC may pull the control pin to the high level to generate a signal pulse when it needs to send the control signal TE2.

The purpose of sending the control signal TE2 to instruct the AP to send images is that, in the bypass mode, the DDIC may directly forward the display data to the display panel to perform refresh without updating the data stored in the frame buffer. Therefore, when the DDIC enters the read/write mode from the bypass mode, those stored in the frame buffer may be older display data. At this time, the DDIC should preferably trigger the AP to transmit the latest display data to update the frame buffer, thereby ensuring that the subsequent display data read out from the frame buffer are correct. As mentioned above, since the AP has stopped updating the image content, it will still transmit the same display data in response to the control signal TE2.

Note that the implementation of using the GPO pin to forward the control signal TE2 is merely an exemplary embodiment of the present invention. In fact, the DDIC may send the control signal TE2 to the AP in any manner. In other embodiments, the control signal TE2 may be sent through any interface connected between the AP and the DDIC, such as the inter-integrated circuit (I2C) interface, serial peripheral interface (SPI), or MIPI, but not limited thereto.

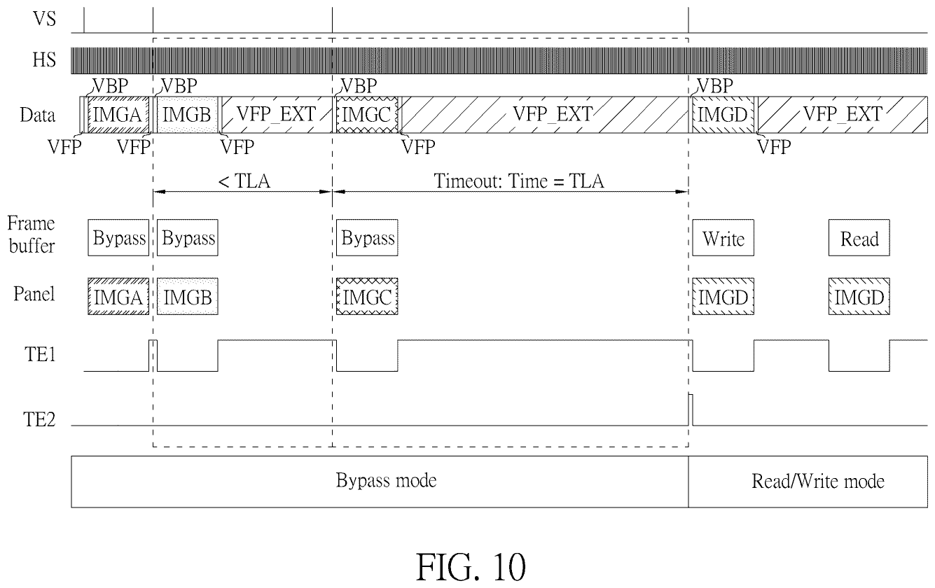

FIG. 10 illustrates a detailed implementation of the DDIC deciding whether to be switched to the read/write mode based on timeout determination. As mentioned above, the DDIC may start counting time, e.g., through a timeout counter or a timer, every time a vertical synchronization signal VS is received. As shown in FIG. 10, in the frame period corresponding to the display data IMGB, the DDIC receives the vertical synchronization signal VS of the next frame of display data IMGC before the occurrence of timeout, i.e., the counted time does not exceed the timeout length TLA. Therefore, the DDIC determines that no timeout occurs and stays in the bypass mode, so that the received display data IMGC are output to the display panel by bypassing the frame buffer. Subsequently, in the frame period corresponding to the display data IMGC, since the frequency of the AP sending images slows down, the DDIC determines that a timeout occurs, and performs a series of steps to enter the read/write mode and instruct the AP to send images through the control signal TE2. The subsequently received display data IMGD will be written into the frame buffer. The detailed operations of mode switching may be found in the above descriptions associated with FIGS. 8 and 9, and will not be repeated herein.

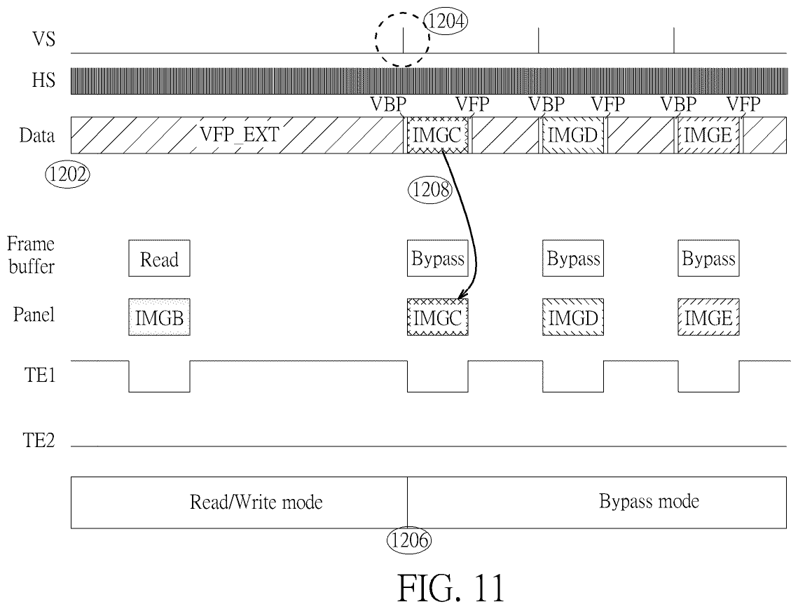

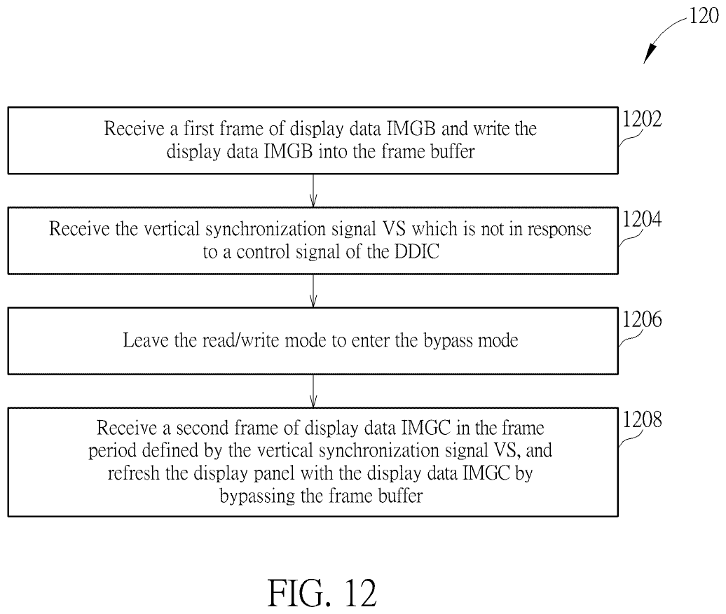

FIG. 11 is a waveform diagram of signal transmission of the DDIC switched from the read/write mode to the bypass mode according to an embodiment of the present invention. FIG. 12 is a flowchart of a control process 120 of the DDIC, which corresponds to the waveforms shown in FIG. 11. As shown in FIG. 12, the control process 120 includes the following steps:

Step 1202: Receive a first frame of display data IMGB and write the display data IMGB into the frame buffer.

Step 1204: Receive the vertical synchronization signal VS which is not in response to a control signal of the DDIC.

Step 1206: Leave the read/write mode to enter the bypass mode.

Step 1208: Receive a second frame of display data IMGC in the frame period defined by the vertical synchronization signal VS, and refresh the display panel with the display data IMGC by bypassing the frame buffer.

Referring to the waveforms of FIG. 11 along with the control process 120 of FIG. 12, the DDIC may be in the read/write mode first. At this time, the AP may not update images and may not send new display data. Therefore, the DDIC may refresh the display panel with a lower frequency by reading out the previously received display data IMGB from the frame buffer. In an exemplary embodiment, the DDIC may refresh the display panel by reading out the display data from the frame buffer with sequentially down-converted frequencies.

Subsequently, the DDIC receives a vertical synchronization signal VS from the AP and the received vertical synchronization signal VS is not in response to a control signal TE2 of the DDIC, which means that the AP starts to actively send images through the MIPI. At this time, the DDIC may determine that the AP is ready to start image updating, and will be automatically switched to the bypass mode from the read/write mode. The DDIC then receives the display data IMGC in the frame period defined by this vertical synchronization signal VS, and outputs the display data IMGC to the display panel for refresh by bypassing the frame buffer. In fact, after entering the bypass mode, the DDIC will directly forward the received display data to the display panel by bypassing the frame buffer until the DDIC returns to the read/write mode. Note that since the image content is updated, the received display data (e.g., IMGC, IMGD, IMGE . . . ) may be at least partially different or entirely different.

As can be seen, in addition to sending the vertical synchronization signal VS, horizontal synchronization signal HS and display data, the AP does not need to send any other command or still indication to the DDIC. The DDIC only needs to determine whether to be switched to the bypass mode according to the image sending behavior of the AP.

Note that the present invention aims at providing a timing control mechanism that allows the DDIC to be switched between the read/write mode and the bypass mode when the display system is operated in the MIPI hybrid mode. Those skilled in the art may make modifications and alterations accordingly. For example, the timing in FIG. 8 or FIG. 10 is only one of various implementations of the DDIC switched from the bypass mode to the read/write mode, and the timing in FIG. 11 is only one of various implementations of the DDIC switched from the read/write mode to the bypass mode. Under the display architecture of the hybrid mode, the display control timing of the present invention may be adjusted or changed in many different aspects, which should all belong to the scope of the present invention.

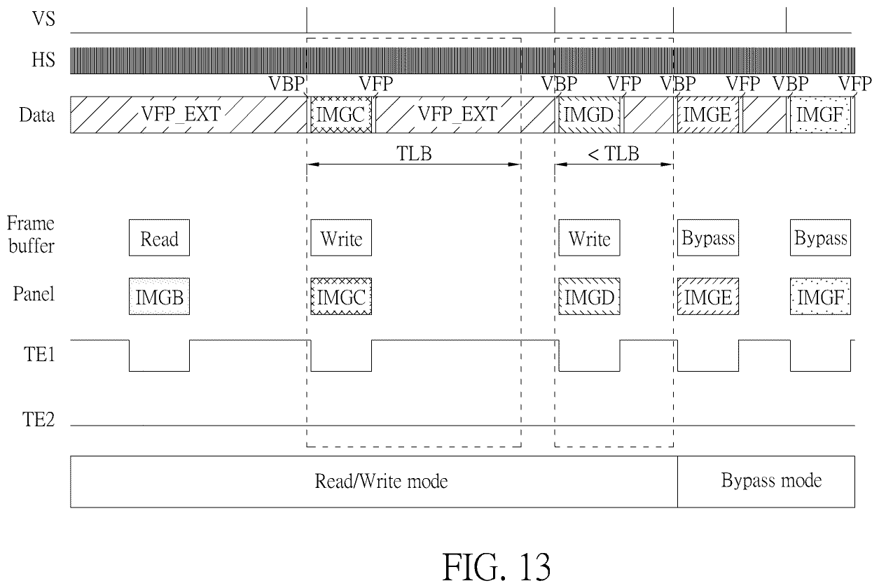

FIG. 13 illustrates another implementation of the DDIC switched from the read/write mode to the bypass mode. In this embodiment, when the DDIC in the read/write mode receives the vertical synchronization signal VS, it does not directly enter the bypass mode. Instead, the DDIC may further determine whether the AP continuously sends new images and/or determine the subsequent image sending frequency of the AP. If the AP still sends images with a lower frequency subsequently, the DDIC may determine that the power saving efficiency of display data refresh through the frame buffer is better, and thus stay in the read/write mode and perform the read/write operations on the frame buffer for panel refresh. Otherwise, if the AP transmits display data with a faster frequency, the DDIC is then switched to the bypass mode.

As shown in FIG. 13, when the DDIC receives the vertical synchronization signal VS and its corresponding display data, it may start counting time in the frame period and perform timeout determination. Similarly, the timeout length may be set according to system requirements. In this embodiment, the setup timeout length may be equal to TLB, which is a threshold for the scenario of triggering the DDIC to be switched from the read/write mode to the bypass mode. The occurrence of timeout may be determined if the counted time reaches the timeout length TLB but the next display data are not received.

In the frame period corresponding to the display data IMGC, the DDIC does not receive the vertical synchronization signal VS of the next image frame before the timeout occurs; hence, the DDIC determines that the AP transmits display data with a slower frequency (i.e., its image sending frequency may be lower than a specific threshold). Therefore, when receiving the next display data IMGD after timeout, the DDIC may stay in the read/write mode and write the display data IMGD into the frame buffer. Subsequently, in the frame period corresponding to the display data IMGD, the DDIC receives the vertical synchronization signal VS of the next frame of display data IMGE before the occurrence of timeout, i.e., the counted time has not reached the timeout length TLB. Therefore, the DDIC may determine that the display data IMGE are received with a frequency greater than a specific threshold, and thus determine that the AP is ready to start a high-speed image sending. In such a situation, the DDIC may be switched to the bypass mode.

In another embodiment, after the DDIC in the bypass mode enters the read/write mode due to the trigger of a timeout, the DDIC will not output the control signal TE2 to instruct the AP to send images. Instead, the DDIC may wait until the AP needs to update the image content and actively transmits new display data to the DDIC, and then write the new display data into the frame buffer. After the new display data are received, the DDIC may update the frame buffer by using the new display data, and start the subsequent panel refresh operations by reading out the display data from the frame buffer.

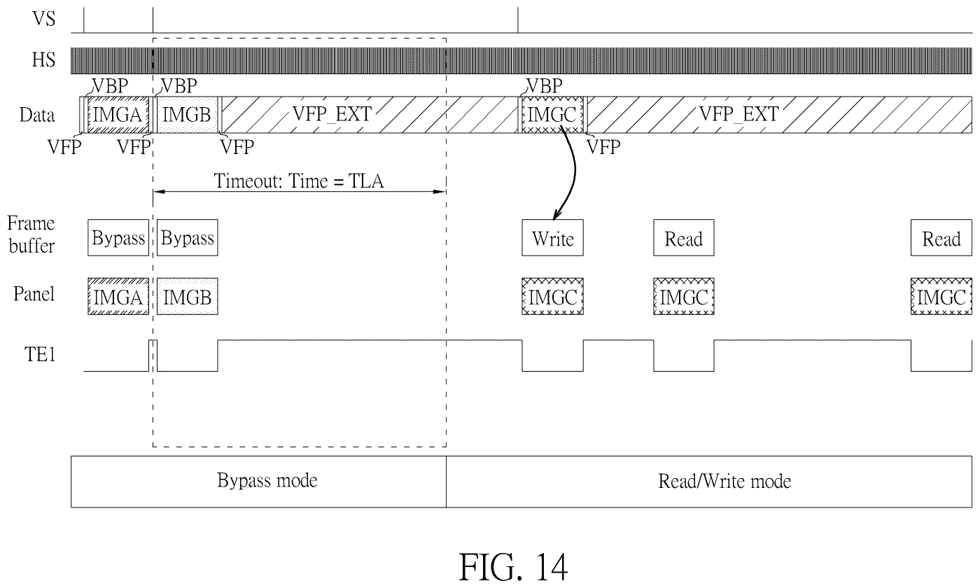

For example, as shown in FIG. 14, after receiving the display data IMGB, the DDIC enters the read/write mode from the bypass mode on the occurrence of timeout. Instead of sending the control signal TE2, the DDIC just waits for the next received display data IMGC and writes the display data IMGC into the frame buffer, and then reads out the display data IMGC from the frame buffer to refresh the display panel. The display data IMGC may be identical to or different from the display data IMGB based on whether the AP updates the images. In this embodiment, the control pin for the control signal TE2 may be omitted.

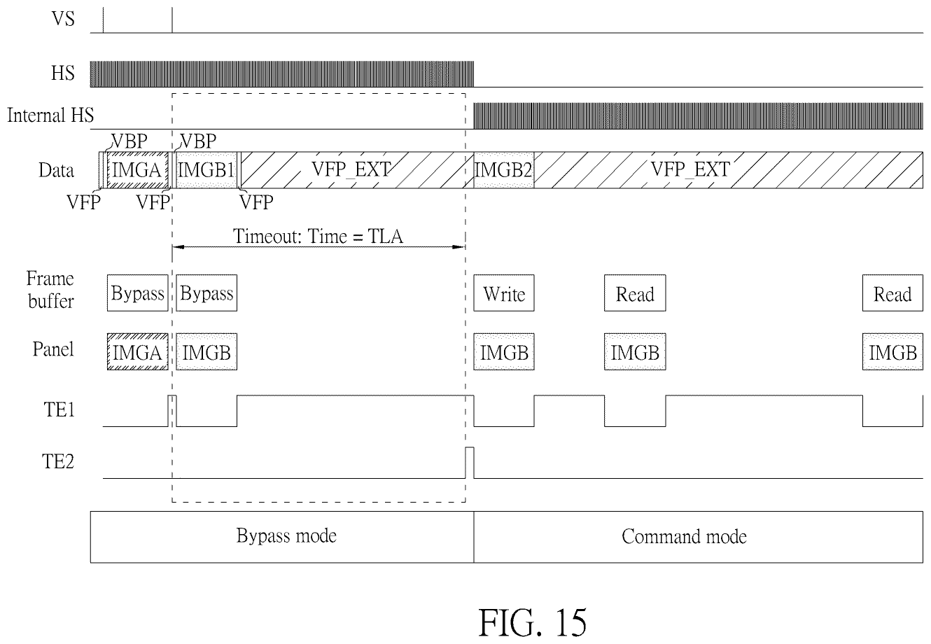

FIG. 15 illustrates another alternative embodiment. In order to further enhance the power saving effect, the AP may disable the MIPI transmission interface during the blank interval where no display data is transmitted, and instead use a GPO interface to send the horizontal synchronization signal HS. Alternatively, the AP may stop sending the horizontal synchronization signal HS when the display data are not updated for a longer time. At this time, the DDIC may generate the horizontal synchronization signal HS internally to use the internal horizontal synchronization signal HS to perform necessary display timing control. As shown in FIG. 15, after the DDIC determines that a timeout occurs and leaves the bypass mode, it may be switched to perform display control with the internal horizontal synchronization signal HS.

In this embodiment, when leaving the bypass mode, the DDIC enters the MIPI command mode to read and write display data, to perform the read/write operations on the display data based on the MIPI specification. The command mode serves to replace the read/write mode of the previous embodiments. When the DDIC enters the command mode, the AP may also send a memory writing packet (not illustrated) to control the DDIC to start the operation of writing the frame buffer. In the command mode, the AP will not send the vertical synchronization signal VS and the horizontal synchronization signal HS through the MIPI, and thus the internal horizontal synchronization signal HS is instead utilized by the DDIC.

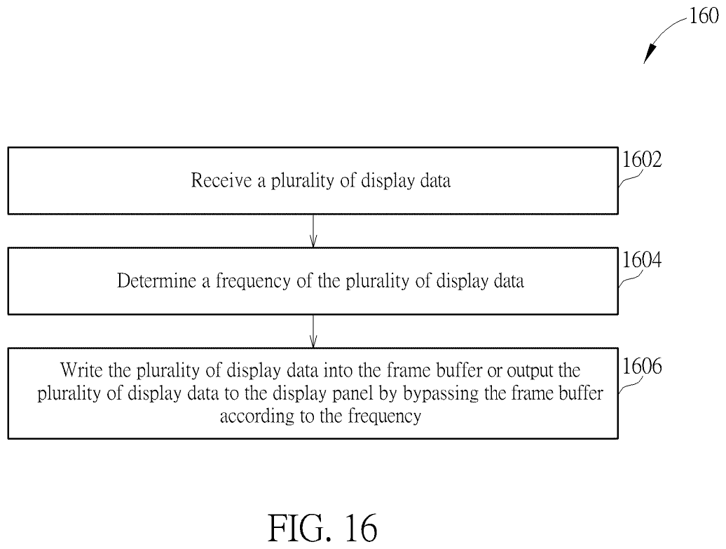

The abovementioned operations of data transmission and panel refresh based on the operation mode may be summarized into a control process 160, as shown in FIG. 16. The control process 160 may be implemented in a display driver circuit, such as the DDIC in any of the above embodiments. As shown in FIG. 16, the control process 160 includes the following steps:

Step 1602: Receive a plurality of display data.

Step 1604: Determine a frequency of the plurality of display data.

Step 1606: Write the plurality of display data into the frame buffer or output the plurality of display data to the display panel by bypassing the frame buffer according to the frequency.

The detailed operations and alterations of the control process 160 are illustrated in the above descriptions, and will not be narrated herein.

In the present invention, the DDIC switches the operation mode according to the behavior of the AP transmitting display data, rather than being instructed by a command sent by the AP, so that the power saving benefits may be optimized. In general, many apps may display still images in most situations, but there are several scenarios where the images need to be updated frequently. If the conventional method of determining whether each app should operate in the still mode or dynamic mode based on the usage scenario is applied, only one of the operation modes can be selected, and the obtained power saving effect may not be satisfactory. A simulation result of long-term operations of mobile phones shows that if the AP determines the usage scenario through the upper layer and uses a still indication to notify the DDIC to switch modes, the saved power consumption is limited. In contrast, through the method of the present invention, the DDIC may apply the bypass mode when the AP sends images in a high speed and apply the read/write mode when the AP stops outputting high-speed display data, where the operation modes may be switched by the DDIC itself according to the image sending behavior of the AP. The power consumption saved is about 10 times that of the conventional method.

To sum up, the present invention provides an operation method applied to the MIPI hybrid mode, to control the DDIC to be switched between the bypass mode and the read/write mode. The DDIC does not receive any command or indication from the AP, but only needs to perform mode switching according to the image sending behavior of the AP. The DDIC in the bypass mode may use a timeout mechanism to determine that the image sending frequency of the AP is lower than a threshold value when the timeout occurs but no vertical synchronization signal is received, and may be switched to the read/write mode accordingly. In an embodiment, the DDIC in the read/write mode may be switched to the bypass mode when receiving images sent by the AP, or switched to the bypass mode when determining that the image sending frequency of the AP is higher than a threshold value through another timeout mechanism. In an embodiment, an additional transmission interface may be joined between the DDIC and the AP, allowing the DDIC to send a control signal when entering the read/write mode, to instruct the AP to send images for updating display data stored in the frame buffer. In another embodiment, the DDIC may not send the control signal when entering the read/write mode; instead, the DDIC waits for the AP updating images and actively outputting the updated display data, then writes the display data into the frame buffer, and performs the subsequent self-refresh operations based on the display data stored in the frame buffer. In an embodiment, the DDIC may also support the command mode, and when the AP stops sending the horizontal synchronization signal, the DDIC may generate an internal horizontal synchronization signal by itself to perform display control. Through the operations of the present invention, the benefits of the command mode and the video mode may be obtained simultaneously in the applications of the hybrid mode, and the obtained power saving effect may be maximized.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of controlling a display panel for a display driver circuit, the display driver circuit having a frame buffer, and the method comprising:
receiving a first frame of display data and sending the first frame of display data to the display panel by bypassing the frame buffer;
starting counting time in a time period for receiving the first frame of display data, to determine whether a timeout occurs;
receiving a second frame of display data after the timeout occurs; and
writing the second frame of display data into the frame buffer.

2. The method of claim 1, further comprising:
outputting a control signal to instruct a host processor to transmit the second frame of display data to the display driver circuit when the timeout occurs.

3. The method of claim 1, wherein the display driver circuit is operated in a first operation mode, and the method further comprises:
leaving the first operation mode to enter a second operation mode when the timeout occurs.

4. The method of claim 3, further comprising:
controlling a plurality of display data received by the display driver circuit to bypass the frame buffer when the display driver circuit is in the first operation mode.

5. The method of claim 3, further comprising:
refreshing the display panel by reading out the second frame of display data from the frame buffer when the display driver circuit is in the second operation mode.

6. The method of claim 5, wherein the second frame of display data is read out from the frame buffer with sequentially down-converted frequencies.

7. The method of claim 3, further comprising:
leaving the first operation mode to enter the second operation mode without being instructed by a command or an indication received from a host processor.

8. The method of claim 1, wherein the second frame of display data is identical to the first frame of display data.

9. The method of claim 1, wherein the step of starting counting time in the time period for receiving the first frame of display data comprises:
starting counting time when receiving a synchronization signal for the first frame of display data.

10. The method of claim 1, wherein the step of starting counting time in the time period for receiving the first frame of display data comprises:
starting counting time when the time period for receiving the first frame of display data starts.

11. The method of claim 1, wherein the step of starting counting time in the time period for receiving the first frame of display data to determine whether the timeout occurs comprises:
determining that the timeout occurs when no vertical synchronization signal is received for a predetermined period of time.

12. The method of claim 1, wherein the display driver circuit comprises a timeout counter used for determining whether the timeout occurs.

13. The method of claim 1, further comprising:
receiving a third frame of display data before the timeout occurs; and
outputting the third frame of display data to the display panel by bypassing the frame buffer.

14. A display driver circuit for controlling a display panel, the display driver circuit having a frame buffer and being to:
receive a first frame of display data and send the first frame of display data to the display panel by bypassing the frame buffer;
start counting time in a time period for receiving the first frame of display data, to determine whether a timeout occurs;
receive a second frame of display data after the timeout occurs; and
write the second frame of display data into the frame buffer.

15. A method of controlling a display panel for a display driver circuit, the display driver circuit having a frame buffer, and the method comprising:
receiving a first frame of display data and writing the first frame of display data into the frame buffer;
receiving a second frame of display data which is not in response to a control signal of the display driver circuit after receiving the first frame of display data; and
outputting the second frame of display data to the display panel by bypassing the frame buffer.

16. The method of claim 15, wherein the second frame of display data is different from the first frame of display data.

17. The method of claim 15, further comprising:
starting counting time in a time period for receiving the first frame of display data to determine a timeout.

18. The method of claim 17, wherein the second frame of display data is received before the timeout occurs.

19. The method of claim 17, further comprising:
receiving a third frame of display data after the timeout occurs; and
writing the third frame of display data into the frame buffer.

20. The method of claim 15, wherein the display driver circuit is operated in a first operation mode, and the method further comprises:
leaving the first operation mode to enter a second operation mode when receiving the second frame of display data.

21. The method of claim 20, further comprising:
refreshing the display panel by reading out the first frame of display data from the frame buffer when the display driver circuit is in the first operation mode.

22. The method of claim 21, wherein the first frame of display data is read out from the frame buffer with sequentially down-converted frequencies.

23. The method of claim 20, further comprising:
controlling a plurality of display data received by the display driver circuit to bypass the frame buffer when the display driver circuit is in the second operation mode.

24. The method of claim 23, wherein the plurality of display data are received with a frequency greater than a predetermined threshold.

25. The method of claim 20, further comprising:
leaving the first operation mode to enter the second operation mode without being instructed by a command or an indication received from a host processor.

26. A display driver circuit for controlling a display panel, the display driver circuit having a frame buffer and being to:
receive a first frame of display data and write the first frame of display data into the frame buffer;
receive a second frame of display data which is not in response to a control signal of the display driver circuit after receiving the first frame of display data; and
output the second frame of display data to the display panel by bypassing the frame buffer.

27. A method of controlling a display panel for a display driver circuit, the display driver circuit having a frame buffer, and the method comprising:
receiving a plurality of display data;
determining a frequency of the plurality of display data; and
writing the plurality of display data into the frame buffer or outputting the plurality of display data to the display panel by bypassing the frame buffer according to the frequency.

28. The method of claim 27, wherein the step of writing the plurality of display data into the frame buffer or outputting the plurality of display data to the display panel by bypassing the frame buffer according to the frequency comprises:
writing the plurality of display data into the frame buffer when the frequency is lower than a first threshold.

29. The method of claim 27, wherein the step of writing the plurality of display data into the frame buffer or outputting the plurality of display data to the display panel by bypassing the frame buffer according to the frequency comprises:
outputting the plurality of display data to the display panel by bypassing the frame buffer when the frequency is higher than a second threshold.

30. A display driver circuit for controlling a display panel, the display driver circuit having a frame buffer and being to:
receive a plurality of display data;
determine a frequency of the plurality of display data; and
write the plurality of display data into the frame buffer or output the plurality of display data to the display panel by bypassing the frame buffer according to the frequency.
